(19) United States
(12) Patent Application Publication
(10) Pub. No.: US 2024/0147531 A1
(43) Pub. Date: May 2, 2024

(54) TXOP PROTECTION FOR RELAY OPERATION

(71) Applicant: NXP USA, Inc., Austin, TX (US)

(72) Inventors: Kiseon Ryu, McLean, VA (US); Liwen Chu, San Ramon, CA (US); Rui Cao, Sunnyvale, CA (US); Hongyuan Zhang, Fremont, CA (US)

(21) Appl. No.: 18/385,712

(22) Filed: Oct. 31, 2023

Related U.S. Application Data
(60) Provisional application No. 63/381,800, filed on Nov. 1, 2022.

(51) Int. Cl. H04W 74/08; H04W 74/04

(52) U.S. Cl. CPC H04W 74/0816; H04W 74/04

(57) ABSTRACT

In an IEEE 802.11 wireless system, a wireless relay STA is configured to receive a MAC control frame to protect a transmission opportunity for a relay operation of frames exchanged between a first STA and a second STA over a wireless relay STA, where the MAC control frame includes TXOP duration information, a receiver address identifying the wireless relay STA, and a transmitter address identifying the first STA, where the wireless relay STA is further configured to transmit an RTS frame in response to receiving the MAC control frame, to receive a CTS frame that is transmitted by the second STA in response to receiving the RTS frame, to transmit a CTS-ACK frame in response to receiving the CTS frame, and to receive and forward a data frame from the first STA which is transmitted at a first TXOP-protected transmission time designated by the TXOP duration information.

### CROSS-REFERENCE TO RELATED APPLICATION AND PRIORITY CLAIM

This application claims the benefit of U.S. Provisional Patent Application No. 63/381,800, entitled “TXOP Protection for Relay Operation” filed on Nov. 2, 2022, which is incorporated by reference in its entirety as if fully set forth herein.

### BACKGROUND

### Field

The present disclosure is directed in general to communication networks. In one aspect, the present disclosure relates generally to range extension frame forwarding in wireless communication systems.

### Description of the Related Art

An ever-increasing number of relatively inexpensive, low power wireless data communication services, networks and devices have been made available over the past number of years, promising near wire speed transmission and reliability. Enabling technology advances in the area of wireless communications, various wireless technology standards (including for example, the IEEE Standards 802.11a/b/g, 802.11n, 802.11ac, 802.11.ax and their updates and amendments, as well as the IEEE Standard 802.11be now in the process of being adopted) have been introduced that are known to persons skilled in the art and are collectively incorporated by reference as if set forth fully herein fully. These standards specify various methods of establishing connections between wireless communication devices (e.g., access points (APs) or non-AP devices) by transmitting various types of information using different transmission techniques. For example, various applications, such as, Internet of Things (IoT) applications can conduct wireless local area network (WLAN) communications, for example, based on Institute of Electrical and Electronics Engineers (IEEE) 802.11 family of standards (e.g., Wi-Fi standards). Some applications, for example, high definition (HD) video surveillance applications, outdoor video sharing applications, etc., require relatively high system throughput as well as good network coverage. However, typical range extension (ER) techniques provide limited wireless transmission range extension. As seen from the foregoing, the existing solutions for wireless communications are extremely difficult at a practical level by virtue of the difficulty in handling increased data signaling loads over longer wireless communication distances while balancing requirements for overhead, processing, and timings costs.

### BRIEF DESCRIPTION OF THE DRAWINGS

The present invention may be understood, and its numerous objects, features and advantages obtained, when the following detailed description of a preferred embodiment is considered in conjunction with the following drawings.

FIG. 1 depicts a block diagram of a wireless communications system with relay transmission capabilities in accordance with selected embodiments of the present disclosure.

FIG. 2 depicts a frame exchange sequence diagram between a transmit station (tSTA), a relay station (rSTA), and a destination station (dSTA) which are connected and configured to perform frame forwarding for range extension in a wireless network.

FIG. 3 depicts a frame exchange sequence diagram between a tSTA, rSTA, and dSTA which perform frame forwarding using conventional RTS and CTS frame signaling in the presence of one or more hidden stations (hSTA).

FIG. 4 depicts a frame exchange sequence diagram between a tSTA, rSTA, and

dSTA which perform frame forwarding using conventional MU-RTS and CTS frame signaling in the presence of one or more hidden stations (hSTA).

FIG. 5 depicts a frame exchange sequence diagram between a tSTA, rSTA, and dSTA which perform frame forwarding using an RTS announcement frame to trigger RTS and CTS frame signaling in combination with responsive CTS frame signaling by the rSTA(s) to confirm protection signaling completion in accordance with selected embodiments of the present disclosure.

FIG. 6 depicts a frame exchange sequence diagram between a tSTA, rSTA, dSTA, and other station that sets a network allocation vector (NAV) value based on the RTS announcement frame received from the tSTA in accordance with selected embodiments of the present disclosure.

FIG. 7 depicts a frame exchange sequence diagram between a tSTA, rSTA, dSTA, and other station accordance with selected embodiments of the present disclosure where the tSTA performs a first error handling procedure if the tSTA does not receive an RTS frame from any rSTA.

FIG. 8 depicts a frame exchange sequence diagram between a tSTA, rSTA, dSTA, and other station accordance with selected embodiments of the present disclosure where the tSTA performs a second error handling procedure if the tSTA does not timely receive an CTS-ACK (or CTS) frame from an rSTA.

FIG. 9 illustrates a message flow signaling sequence during operation of a plurality of wireless communication station devices which use a defined MAC control frame and a sequence of RTS, CTS, and CTS-ACK (or CTS) frame signaling messages to protect or hold a transmission opportunity (TXOP) for a relay operation of a data frame in accordance with selected embodiments of the present disclosure.

### DETAILED DESCRIPTION

A system, apparatus, and methodology are described for a wireless communication system where a transmitting station (tSTA) device transmits a MAC control frame (e.g., a Request to Send Announcement (RTSA) frame, a modified multi-user RTS Triggered TXOP Sharing (MU-RTS TXS) Trigger frame, etc.) to protect or hold a transmission opportunity (TXOP) for a relay operation of frames exchanged between the tSTA device and a destination station (dSTA) device over a relay station (rSTA) device. The MAC control frame transmitted by the tSTA device triggers transmission of an RTS frame (or an MU-RTS Trigger frame) from an rSTA device if the wireless medium is idle at the rSTA device. In response to the MAC control frame, the rSTA and dSTA devices are configured to exchange RTS (or MU-RTS) and Clear to Send (CTS) frames which protect the transmission opportunity for the tSTA device to transmit one or more frames to the rSTA device for relay delivery to the dSTA device and to receive one or more immediate response frame from the dSTA device over the rSTA device. To confirm protection signaling completion, the rSTA device may be configured to send a CTS frame (e.g., named as a CTS-ACK frame) to the tSTA device or to the rSTA device itself.

In the context of the present disclosure, it will be understood by those skilled in the art that that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present disclosure may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussions of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize, in light of the description herein, that the disclosure can be practiced without one or more of the specific features or advantages of a particular embodiment. In other instances, additional features and advantages may be recognized in certain embodiments that may not be present in all embodiments of the disclosure.

References throughout this specification to “one embodiment”, “an embodiment,” “selected embodiments,” or similar language means that a particular feature, structure, or characteristic described in connection with the indicated embodiment is included in at least one embodiment of the present disclosure. Thus, the phrases “in one embodiment”, “in an embodiment,” “selected embodiments,” and similar language throughout this specification may, but do not necessarily, all refer to the same embodiment.

Range extension (ER) PPDU formats are introduced from IEEE 802.11ax and carried over to IEEE 802.11be and beyond. Direct sequence spread spectrum (DSSS) is also defined in IEEE 802.11b in 2.4 GHz band with longer range. However, these ER physical layer (PHY) modes can provide limited transmission range extension (e.g., 3 dB˜6 dB), and the sustainable data rate is reduced to 1˜3 mbps. Relay forwarding has been defined as independent transmission for each hop which can induce long latency and jitter. For example, typical WiFi extender/repeater/boosters have long end-to-end latency, high jitter, and low throughput. In a WiFi mesh router or EasyMesh program, each mesh router is interconnected with another mesh router through either wire or wireless. For wireless connection, every AP can relay the data from a master AP to its own stations (STAs). Each mesh node has a full function AP and at least one full function STA, thus is not cost effective. The AP relaying protocol is built on top of existing IEEE 802.11 Medium Access Control (MAC)/PHY components, latency/jitter is also high compared to single-hop case. For IEEE 802.11 11ah/ad relaying mode, end to end latency and throughput may not be guaranteed with hop-by-hop block acknowledgement (BA)/acknowledgement (ACK) agreement and security protocol.

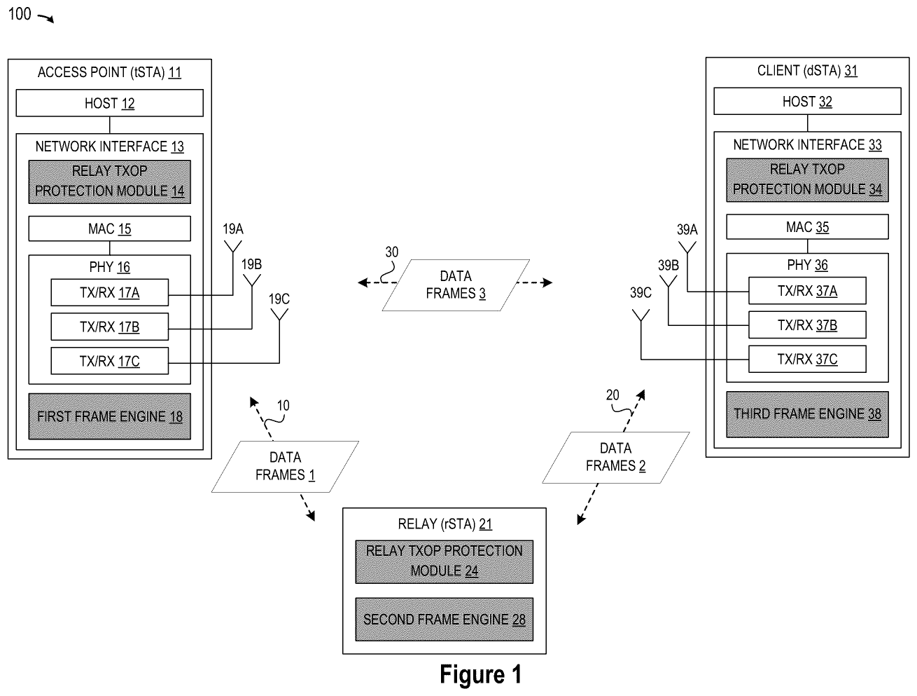

To provide a contextual understanding for selected embodiments of the present disclosure, reference is now made to FIG. 1 which depicts a block diagram of a wireless local area network (WLAN) 100 with relay transmission capabilities wherein an access point (AP) 11 and one or more wireless devices 31 transmit and receive aggregated data frames 1-2 using a relay wireless device 21. To simplify the present disclosure, FIG. 1 will be used to illustrate both the conventional approaches and Applicant's disclosed approaches for relaying data frames with controlled transmission operation protection in a wireless communication system.

As depicted in FIG. 1, an access point (AP) device 11 may operate as a transmitter station (tSTA) device which transmits one or more data frames 1 to a relay station (rSTA) device 21 which is located in a signal path between the AP 11 and a client or destination station (dSTA) device 31 and which is configured to forward one or more data frames 2 from the AP 11 and the dSTA 31. In other embodiments, the direction of data frame relay transmission may be reversed from the transmitting client device 31 to the AP 11. In some embodiments, the rSTA is configured to decode and forward data frames that are received from the AP 11 to the dSTA 31 and/or from the dSTA 31 to the AP 11.

As depicted, the AP 11 includes a host processor 12 coupled to a network interface 13. In selected embodiments, the network interface 13 includes one or more integrated circuits (IC) devices configured to operate a local area network (LAN) protocol. To this end, the network interface 13 may include a medium access control (MAC) processor 15 and a physical layer (PHY) processor 16. In selected embodiments, the MAC processor 15 is implemented as an 802.11bn MAC processor 15, and the PHY processor 16 is implemented as an 802.11bn PHY processor 16. The PHY processor 16 includes a plurality of transceivers 17 which are coupled to a plurality of antennas 19. Although three transceivers 17A-C and three antennas 19A-C are illustrated, the AP 11 may use any suitable number of transceivers 17 and antennas 19 in other embodiments. In addition, the AP 11 may have more antennas 19 than transceivers 17, in which case antenna switching techniques are used to switch the antennas 19 between the transceivers 17. In selected embodiments, the MAC processor 15 is implemented with one or more integrated circuit (IC) devices, and the PHY processor 16 is implemented on one or more additional IC devices. In other embodiments, at least a portion of the MAC processor 15 and at least a portion of the PHY processor 16 are implemented on a single IC device.

In various embodiments, the MAC processor 15 and the PHY processor 16 are configured to operate according to at least a first communication protocol (e.g., 802.11bn). In other embodiments, the MAC processor 15 and the PHY processor 16 are also configured to operate according to one or more additional communication protocols (e.g., according to the IEEE 802.11 be Standard). Using the communication protocol(s), the AP device 11 is operative to create a wireless local area network (WLAN) 100 in which the AP 11 may communicate over one or more relay stations (e.g., 21) with one or more client stations (e.g., 31) located within the WLAN 10. Although a single relay station 21 and client station 31 are illustrated in FIG. 1, the WLAN 100 may include any suitable number of relay stations and client stations in various scenarios and embodiments.

At least one of the client stations (e.g., client station 31) is configured to operate at least according to the first communication protocol. To this end, the client station 31 includes a host processor 32 coupled to a network interface 33. In selected embodiments, the network interface 33 includes one or more IC devices configured to operate as discussed below. For example, the depicted network interface 33 may include a MAC processor 35 and a PHY processor 36. In selected embodiments, the MAC processor 35 is implemented as an 802.11bc MAC processor 35, and the PHY processor 36 is implemented as an 802.11bc PHY processor 36. The PHY processor 36 includes a plurality of transceivers 37 coupled to a plurality of antennas 39. Although three transceivers 37A-C and three antennas 39A-C are illustrated, the client station 31 may include any suitable number of transceivers 37 and antennas 39. In addition, the client station 31 may include more antennas 39 than transceivers 37, in which case antenna switching techniques are used. In selected embodiments, the MAC processor 35 is implemented on at least a first IC device, and the PHY processor 36 is implemented on at least a second IC device. In other embodiment, at least a portion of the MAC processor 35 and at least a portion of the PHY processor 36 are implemented on a single IC device. As will be appreciated, each relay station 21 may have a structure that is the same as or similar to the client station 31, though there can be structural differences.

The wireless local area network (WLAN) 100 can be used in various applications, such as industrial applications, medical applications, computer applications, and/or consumer or enterprise applications. In some embodiments, the wireless local area network (WLAN) 100 is compatible with an IEEE 802.11 protocol. Although the depicted wireless local area network (WLAN) 100 is shown with certain components and described with certain functionality herein, other embodiments of the wireless communications system may include fewer or more components to implement the same, less, or more functionality. For example, in some embodiments, the wireless local area network (WLAN) 100 includes multiple APs with one rSTA and one dSTA, multiple APs with multiple rSTAs and one dSTA, multiple APs with one rSTA and multiple dSTAs, multiple APs with multiple rSTAs and multiple dSTAs, one AP with one rSTA and multiple dSTAs, or one AP with multiple rRSTAs and multiple dSTAs. In another example, although the wireless local area network (WLAN) 100 is shown as being connected in a certain topology, the network topology of the wireless local area network (WLAN) 100 is not limited to the this topology. In some embodiments, the wireless local area network (WLAN) 100 involves single-link communications and the AP 11, the rSTA 21, and the dSTA 31 communicate through single communications links. In some embodiments, the wireless local area network (WLAN) 100 involves multi-link communications and the AP 11 (that is affiliated with an AP multi-link device (MLD)), the rSTA 21 (that is affiliated with either a relay MLD, an AP MLD or a non-AP MLD), and the dSTA 31 (that is affiliated with a non-AP MLD) communicate through one link of multiple communications links. Furthermore, the techniques described herein may also be applicable to each link of a multi-link communications system.

As disclosed, the AP 11 communicates with the rSTA 21 via a communication link 10 (e.g., a wireless link), and the rSTA 21 communicates with the dSTA 31 via a communication link 20 (e.g., a wireless link). The rSTA 21 is located between the AP 11 and the dSTA 31 to forward data frame 1 to the dSTA 31 (e.g., decode and forward data received successfully from the AP 11 to the dSTA 31) and/or to forward data frames 2 to the AP 11 (e.g., decode and forward data frames 2 received successfully from the dSTA 31 to the AP 11). In some embodiments, data frames communicated between the AP11, the rSTA 21, and the dSTA 31 include MAC protocol data units (MPDUs). An WIPDU may include a frame header, a frame body, and a trailer with the WIPDU payload encapsulated in the frame body. When data transfer is performed with two channel access, the system throughput of the wireless local area network (WLAN) 100 may be halved linearly. The rSTA 21 provides flexibility to achieve higher rate with shorter communications links 10, 20. In some embodiments, the AP 11 can directly communicate with the dSTA 31 by exchanging data frames 3 via a communication link 30. Compared to the communications links 10, 20 the communication link 30 can have twice the distance, which corresponds to around 8 dB propagation loss (2.7 decaying exponent). Although the AP 11, the rSTA 21, and the dSTA 30 are depicted as wirelessly communicating to each other via a corresponding communications link 10, 20, 30, in other embodiments, the AP 11, the rSTA 21, and the dSTA 31 may wirelessly communicate to each other via multiple communication links.

In some embodiments employing point-to-point (P2P) communications, the AP 11 is replaced by a non-AP STA. In some embodiments, the rSTA 21 includes a relay STA that performs frame exchanges with the AP 11 and a relay AP that performs frame exchanges with the dSTA 31 and a relay functionality between the relay STA and the relay AP.

In selected embodiments, the rSTA 21 is used when the associated AP 11 cannot reach a remote STA (e.g., the dSTA 31) with high Modulation and Coding Scheme (MCS), number of spatial streams (NSS) or cannot reach a remote STA (e.g., the dSTA 31) with the lowest MCS. The uplink (UL) frame transmission between the dSTA 31 and the AP 11 may be done by PPDU data frames 2 transmitted from the dSTA 31 to the rSTA 21, and PPDU data frames 1 transmitted by the rSTA 21 to the AP 11. The downlink (DL) frame transmission between the AP 11 and dSTA 31 may be done by PPDU data frames 1 transmitted by the AP 11 to the rSTA 21, and PPDU data frames 2 transmitted by the rSTA 21 to the dSTA 31.

In response to the transmitted PPDU data frames 1, 2, block acknowledgement (BA)/acknowledgement (ACK) frames can be end-to-end or hop-by-hop. With end-to-end BA, the DL BA transmitted by the AP 11 may acknowledge the soliciting UL Aggregate MAC Protocol Data Unit (A-MPDU)/block acknowledgement request (BAR) from the dSTA 31 that is forwarded by the rSTA 21. Similarly, the DL BA transmitted by the AP 11 may acknowledge the soliciting A-MPDU/BAR from the dSTA 31 that is forwarded by the rSTA 21. With hop-by-hop DL BA, the DL BA transmitted by the AP 11 may acknowledge the soliciting UL A-MPDU/BAR from the rSTA 21, and the DL BA transmitted by the rSTA 21 may acknowledge the soliciting UL A-MPDU/BAR from the dSTA 31. With hop-by-hop UL BA, the UL BA transmitted by the rSTA 21 may acknowledge the soliciting DL A-MPDU/BAR from the AP 11, and the UL BA transmitted by the dSTA 31 may acknowledge the soliciting DL A-MPDU/BAR from the rSTA 21.

In the WLAN 100, the AP or tSTA 11, rSTA 21 and dSTA 31 each include relay transmission opportunity (TXOP) modules 14, 24, 34 which operate to protect or hold a transmission opportunity (TXOP) for a relay operation of a data frame transmitted by the AP/tSTA 11 over the rSTA 21 to the dSTA 31. In support of the relay TXOP modules 14, 24, 34, the AP or tSTA 11 includes a first frame engine 18 which is configured to generate and transmit a first MAC control frame (e.g., an RTS Announcement (RTSA) frame, a modified MU-RTS TXS Trigger frame, etc.) that the relay TXOP protection module 14 transmits as a data frame 1 from the AP/tSTA 11 to the rSTA 21. In addition, the rSTA 21 includes a second frame engine 28 which is configured to generate and exchange Request to Send (RTS) (or MU-RTS) and Clear to Send (CTS) frames which protect the transmission opportunity for the AP/tSTA 11 to transmit a first PPDU data frame 1 to the rSTA 21 for relay delivery as a second PPDU data frame 2 to the dSTA 31. In particular, the second frame engine 28 is configured to respond to the MAC control frame by generating an RTS (or an MU-RTS) frame that the relay TXOP protection module 24 transmits as a data frame 2 from the rSTA 21 to the dSTA 31. The second frame engine 28 is also configured to respond to receiving a CTS frame from the dSTA 31 by generating a CTS (or CTS-ACK) frame that the relay TXOP protection module 24 transmits as a data frame 1 from the rSTA 21 to the tSTA 11. In addition, the dSTA 31 includes a third frame engine 38 which is configured to respond to receiving a RTS (or an MU-RTS) frame from the rSTA 21 by generating a CTS frame that the relay TXOP protection module 34 transmits as a data frame 2 from the dSTA 31 to the rSTA 21. To confirm protection signaling completion, the third frame engine 38 may be configured to respond to a receiving a relayed data frame 2 from the rSTA 21 by generating an acknowledgement frame (e.g., multi-STA block Ack (M-BA)) that the relay TXOP protection module 34 transmits as a data frame 2 from the dSTA 31 to the rSTA 21. In addition, the second frame engine 28 may be configured to respond to a receiving a relayed data frame 2 from the dSTA 31 by generating an acknowledgement frame (e.g., M-BA) that the relay TXOP protection module 24 transmits as a data frame 1 from the rSTA 21 to the AP/tSTA 11.

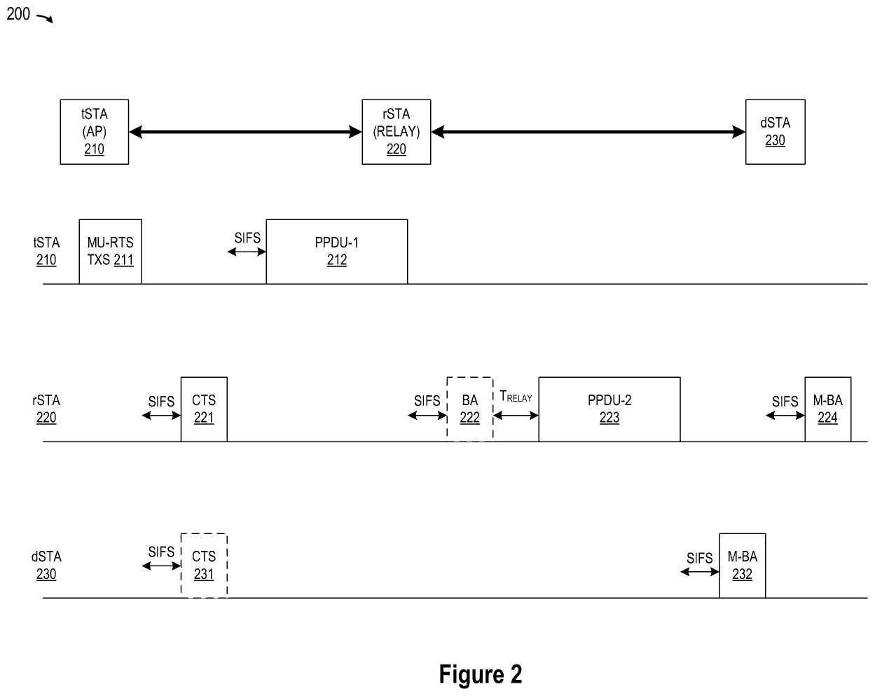

With earlier 802.11 protocols, AP 11 was able to use a relay STA 21 that was associated with the AP 11 to communicate data frames to a client STA 31 when the AP 11 could not reach the remote client STA 31 with high MCS, Nss, or could not reach remote client STA 31 with the lowest MCS. To illustrate an example of such an earlier 802.11 protocol, reference is now made to FIG. 2 which depicts a frame exchange sequence diagram 200 between a transmit station (tSTA) 210, a relay station (rSTA) 220, and a destination station (dSTA) 230 which are connected and configured to perform frame forwarding for range extension and throughput enhancement in a wireless network. In the frame exchange sequence diagram 2, the tSTA 210 may be implemented the same as or similar to the AP 11 depicted in FIG. 1, while the rSTA 220 and the dSTA 230 may be implemented the same as or similar to the rSTA 21 and the dSTA 31 depicted in FIG. 1, respectively. In the frame exchange sequence diagram 2, transmit opportunity (TXOP) sharing relay communications with one relay are implemented. A Multi User Request to Send (MU-RTS) triggered TXOP sharing (TXS) frame 211 may be sent by the tSTA 210 to reserve the TXOP for both hops (i.e., the tSTA 210 and the rSTA 220), and a portion of the TXOP is shared with the rSTA 220. The rSTA and/or the dSTA may transmit a Clear to Send (CTS) message or frame 221, 231 in response to the MU-RTS TXS frame 211. The tSTA 210 transmits a Physical layer Protocol Data Unit (PPDU) PPDU-1 212 to the rSTA 220. For example, in the MU-RTS TXS frame 211, the tSTA 210 reserves a 5 millisecond (ms) TXOP, out of which 3 ms is allocated to the rSTA 220, and the tSTA 210 uses 2 ms for PPDU-1 212 transmission. The rSTA 220 can perform data forwarding by decoding and forwarding. As indicated by the dashed lines, the transmission of BA 222 from the rSTA back to the tSTA 210 may be either skipped or performed if an end-to-end BA agreement is set up. The relay processing delay (T RELAY) is either pre-defined for any relays (e.g., being equal to Short Interframe Spacing (SIFS)), or per-determined by the rSTA 220. The rSTA 220 forwards or retransmits successfully received MPDUs carried in PPDU-1 212 in a Physical layer Protocol Data Unit (PPDU) PPDU-2 223 to the dSTA 230. The dSTA 230 sends an acknowledgement frame (e.g., Ack, BA, or M-BA) 232 back to the rSTA 220, which may forward the received acknowledgement frame with another acknowledgement frame (e.g., M-BA) 224 back to the tSTA 210. The Modulation and Coding Scheme (MCS)/number of spatial streams (NSS) for the PPDU-2 223 may be informed to the rSTA 220 with the information embedded in PPDU-1 212 or in a separate management frame. If the TXOP duration is not sufficient, the rSTA 220 may choose to drop some MPDUs. In some embodiments, for point-to-point (P2P) communications, the tSTA 210 is replaced by another non-AP STA. In some embodiments, the rSTA 220 includes a relay STA that performs frame exchanges with the tSTA 210 and a relay AP that performs frame exchanges with the dSTA 230 and a relay functionality between the relay STA and the relay AP.

In selected embodiments of data frame relay operations, uplink (UL) frame transmissions between the dSTA 230 and AP 210 are performed by transmitting a first PPDU 212 from the dSTA 230 (e.g., non-AP STA) to the rSTA 220, and then transmitting a second PPDU 223 from the rSTA 220 to the tSTA 210 (e.g., AP). Conversely, downlink (DL) frame transmission between AP 210 and the dSTA 230 are performed by transmitting a first PPDU 212 from the tSTA 210 (e.g., AP) to the rSTA 220, and then transmitting a second PPDU 223 from the rSTA 220 to the dSTA 230 (e.g., non-AP STA). The block acknowledgement (BA)/acknowledgement (ACK) can be end-to-end or hop-by-hop. With end-to-end BA, the DL BA transmitted by the AP 210 may acknowledge the soliciting UL Aggregate MAC Protocol Data Unit (A-MPDU)/block acknowledgement request (BAR) from the dSTA 230 that is forwarded by the rSTA 220, and the UL BA transmitted by the non-AP STA may acknowledge the soliciting DL A-MPDU/BAR from the AP 210 that is forwarded by the rSTA 220. With hop-by-hop DL BA, the DL BA transmitted by the AP 210 may acknowledge the soliciting UL A-MPDU/BAR from the rSTA 220, and the DL BA transmitted by the rSTA 220 may acknowledge the soliciting UL A-MPDU/BAR from the dSTA 230. With hop-by-hop UL BA, the UL BA transmitted by the rSTA 220 may acknowledge the soliciting DL A-MPDU/BAR from the AP 210, and the UL BA transmitted by the dSTA 230 may acknowledge the soliciting DL A-MPDU/BAR from the rSTA 220.

There are other approaches for protecting transmission operations during Ultra High Reliability (UHR) relay operations with use RTS frames to signal that an AP/tSTA will use a relay STA to communicate data frames from the AP/tSTA to a dSTA. For example, an initiator device (e.g., tSTA) can provide TXOP protection by configuring the initiator device to generate and send a first RTS frame in a UHR PPDU that is transmitted by the tSTA to a relay device (e.g., rSTA). In addition, the relay device may be configured to generate and send a second RTS frame in a UHR PPDU that is transmitted by the rSTA to a destination device (e.g., dSTA). In addition, the destination device may be configured to generate and send a first CTS frame in a UHR PPDU that is transmitted by the dSTA to the relay device (e.g., rSTA). In addition, the relay device may be configured to generate and send a second CTS frame in a UHR PPDU that is transmitted by the rSTA to the initiator device (e.g., tSTA). Finally, the initiator device (e.g., tSTA) and destination device (e.g., dSTA) may each be configured to generate and send a non-high throughput (HT) duplicate PPDU. In this UHR relay scenario, the destination device knows exactly the transmission time of the CTS frame in the UHR PPDU by rSTA (e.g., the Tx time of CTS frame in the UHR PPDU by the relay device (e.g., rSTA) is the same as the Tx time of the CTS frame in the UHR PPDU by the destination device (e.g., dSTA). In addition or in the alternative, the relay device may be configured to generate and use a CTS-To-Self message before the transmission of the RTS frame in the UHR PPDU to the destination device. In this relay operation arrangement, the initiator device (e.g., tSTA) is configured to generate and send a specifically defined UHR PPDU to announce the forwarding of a frame in a PPDU other than a UHR PPDU. If the frame carries the forwarding indication, the specifically defined UHR PPDU is not needed. In other embodiments, the initiating device may transmit CTS-to-Self before the RTS transmission, where the CTS-to-Self frame has a receiver address (RA) field set to the value of the transmitter address (TA) field.

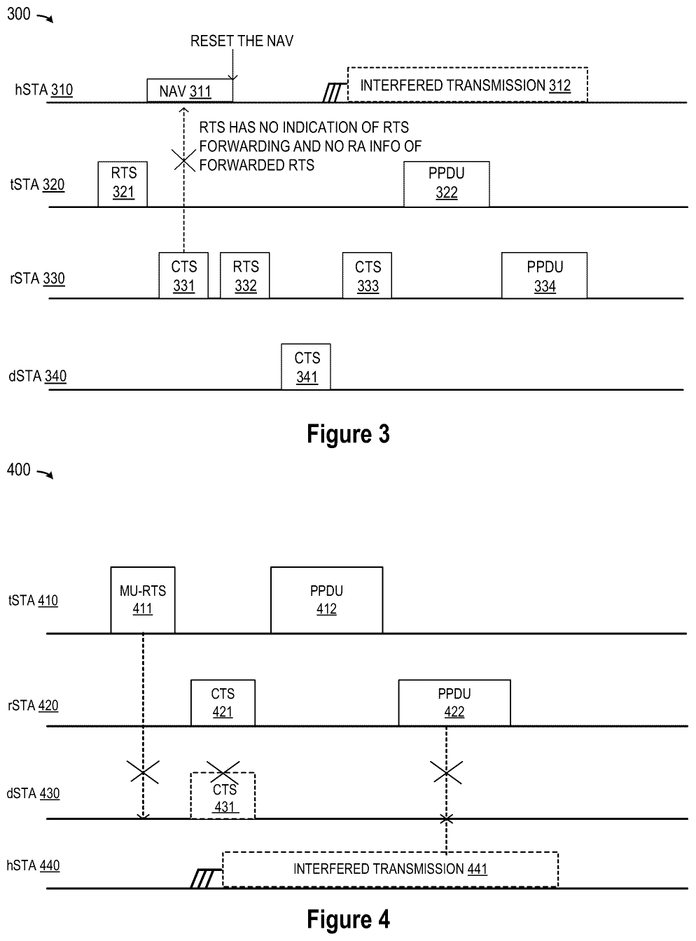

To illustrate additional limitations of existing approaches for protecting transmission operations, reference is now made to FIG. 3 which depicts a frame exchange sequence diagram 300 illustrating a relay TXOP protection signaling sequence between a tSTA 320, rSTA 330, and dSTA 340 which perform frame forwarding using conventional RTS and CTS frame signaling in the presence of one or more hidden stations (hSTA) 310 in a wireless communication system. In normal relay operation, the tSTA 320 provides TXOP protection by generating and transmitting a first RTS frame 321 which is received by the rSTA 330 and also the hSTA 310. In response to the first RTS frame 321, the rSTA 330 generates and transmits a first CTS frame 331 to at least the tSTA 320 which signals that the channel to the rSTA 330 is clear to send. After transmitting the CTS 331, the rSTA 330 generates and transmits a second RTS frame 332 which is received by at least the dSTA 340. In response to the second RTS frame 332, the dSTA 340 generates and transmits a second CTS frame 341 to the rSTA 330. In response to the second CTS frame 341, the rSTA 330 generates and transmits a third CTS frame 333 to the tSTA 320 to confirm the transmission operation protecting, thereby enabling the tSTA 320 to transmit the first PPDU frame 322 to the rSTA 330, and then enabling the rSTA 330 to transmit the second PPDU frame 334 to the dSTA 340.

The problem which arises with depicted frame exchange sequence diagram 300 is that conventional RTS and CTS frame signaling may not work for relay operations in cases where there may be one or more hidden stations (hSTA) 310 which can interfere with the TXOP relay protection operation. In particular, if there is any additional hidden station (hSTA) 310 that receives the first RTS frame 321, the hSTA 311 may be configured to defer its channel access for a defined period that is set by a duration field in the MAC header of the RTS frame 321 received from the tSTA 320. This channel deference by the hSTA 310 is indicated by the network allocation vector (NAV) block 311, and would ordinarily extend for TXOP protection during which the PPDU frames 322, 334 are transmitted. However, if the hSTA 310 receives the first RTS frame 321 from the tSTA 320, but does not receive a CTS frame 331 from the rSTA 330 (as indicated by the “X” across the dashed line), the hSTA 310 may be configured with a NAV reset operation which terminates the channel deference mode, thereby potentially causing interfered transmission 312 from collision of frames transmitted by the hSTA 310 during a relay TXOP. In addition, another problem is that the first RTS frame includes only the RA field set to the rSTA's address and the TA field set to the tSTA's address. That is, the rSTA does not obtain the information of the RA field of the second RTS frame from the first RTS frame. As seen from the foregoing, the RTS/CTS frame signaling should be backward compatible, and the related control frames should be transmitted in non-HT (duplicate) PPDU to support the legacy STAs.

To illustrate additional limitations of existing approaches for protecting transmission operations, reference is now made to FIG. 4 which depicts a frame exchange sequence diagram 400 illustrating a relay TXOP protection signaling sequence between a tSTA 410, rSTA 420, and dSTA 430 which perform frame forwarding using conventional MU-RTS and CTS frame signaling in the presence of one or more hidden stations (hSTA) 440 in a wireless communication system. In normal relay operation, the tSTA 410 provides TXOP protection by generating and transmitting an MU-RTS frame 411 which is received by the rSTA 420 and the dSTA 430. In response to the MU-RTS frame 411, the rSTA 420 and dSTA 430 each generate and transmit corresponding CTS frames 421, 431 to at least the tSTA 410 which signals that the channel to the rSTA 420 and dSTA 430 is clear to send. In response to the CTS frames 421, 431 which confirm that transmission operation is protected, the tSTA 410 transmits the first PPDU frame 412 to the rSTA 420, and then enabling the rSTA 420 to transmit the second PPDU frame 422 to the dSTA 430.

The problem which arises with depicted frame exchange sequence diagram 400 is that conventional MU-RTS and CTS frame signaling may not work for relay operations in cases where there may be one or more hidden stations (hSTA) 440 which can interfere with the TXOP relay protection operation. In particular, any additional hidden station (hSTA) 440 that receives the CTS frame 431 from the dSTA 430 may be configured to respond to the CTS frame 431 by deferring its channel access for a defined period that is set by a TXOP protection duration field. However, due to the limited direct link transmission coverage, the dSTA 430 may not receive the MU-RTS frame 411 (as indicated by the “X” across the dashed line extending down from the MU-RTS 411). In this case, the dSTA 430 does not generate and transmit a CTS frame 431 (as indicated by the “X” across the CTS frame 431) that would be received by the hSTA 440. As a result of the hSTA 440 not receiving the CTS frame 431, the hSTA 440 is not configured to defer its channel access for the TXOP protection duration field, thereby potentially causing interfered transmission 441 from collision with the second PPDU frame 422 transmitted by the rSTA 420 to the dSTA 430 (as indicated by the “X” across the dashed line extending down from the PPDU 422). The reason for this is that the tSTA411 which receives CTS frames 421, 431 sent by the rSTA 420 and dSTA 430 may not know which STA transmitted or did not transmit the received CTS frame since the CTS frames could be transmitted in the same or the overlapping frequency bandwidth.

To address these limitations from conventional relay TXOP protection solutions and others known to those skilled in the art, there is disclosed herein a wireless communication station device, system, apparatus, and methodology for frame forwarding operations between a tSTA, rSTA, and dSTA devices by using a MAC control frame that is transmitted by an AP/tSTA to trigger RTS (or MU-RTS) and CTS frame exchanges between the rSTA device(s) and the dSTA device in combination with responsive CTS frame signaling by the rSTA device to confirm protection signaling completion in accordance with selected embodiments of the present disclosure, thereby extending the range of data frame transmissions from the AP/tSTA to the dSTA. Referring back to FIG. 1, this capability is provided in the wireless local area network (WLAN) 100 where each of the wireless devices 11, 21, 31 41 is a wireless communication station (STA) device which is respectively configured with relay transmission opportunity (TXOP) modules 14, 24, 34 and frame engines 18, 28, 38 which operate to protect or hold a transmission opportunity (TXOP) for a relay operation of a data frame transmitted by the AP/tSTA 11 over the rSTA 21 to the dSTA 31. By configuring the AP/tSTA device 11 to generate the MAC control frame as a dedicated RTS announcement (RTSA) frame or modified MU-RST TXS frame that includes a receiver address information of the MAC control frame (e.g., MAC address of the rSTA 21) and a receiver address information of the triggered RTS frame (e.g., MAC address of the dSTA 31), the RTSA frame conveys the addresses for the relay station (rSTA 21) and the destination station (dSTA 31) to effectively protect relay transmission operations from the tSTA to the dSTA, even in the presence of hidden stations.

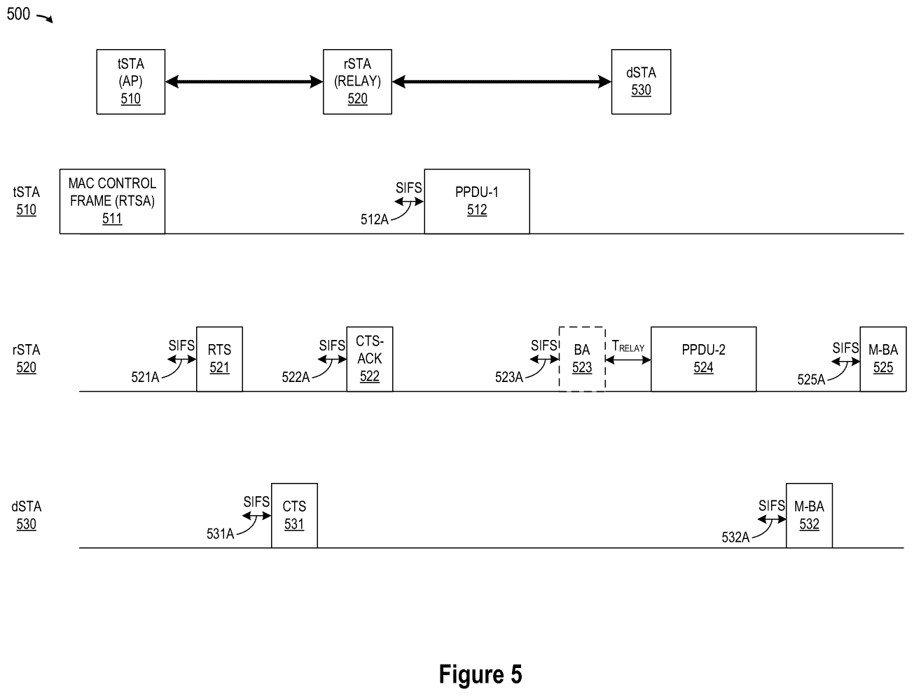

To provide additional details for an improved understanding of selected embodiments of the present disclosure, reference is now made to FIG. 5 which is a simplified illustration 500 of a plurality of wireless communication station (STA) devices 510, 520, 530 which perform frame forwarding using a MAC control frame (e.g., RTS announcement (RTSA) frame) from a transmit STA 510 to trigger RTS (or MU-RTS) and CTS frame exchanges between a relay station 520 and a destination station 530 in combination with responsive CTS frame signaling by the relay station 520 to confirm TXOP protection signaling completion. As depicted, the first transmit station (tSTA) device 510 sends a MAC control frame 511 to protect or reserve a transmission opportunity (TXOP) for a relay operation of frame exchange between the tSTA device 510 and a destination station (dSTA) device 530 over a relay station (rSTA) device 520. The MAC control frame 511 may take any suitable structure or form, such as a Request to Send Announcement (RTSA) frame or a modified MU-RST TXS frame. At a minimum, the MAC control frame 511 includes a TXOP duration field, at least one address information of the rSTA 520 (e.g., MAC address, Association IDentifier (AID)) that will transmit an RTS (or an MU-RTS) frame 521 after a Short Interframe Spacing (SIFS) delay 521A after the RTSA frame 511, and an address information of the dSTA device 530 (e.g., MAC address, AID) that will receive the RTS (or MU-RTS) frame 521. In some embodiments, the transmitter address (TA) field of the defined MAC control frame 511 is set to the MAC address of the tSTA device 510, and the receiver address (RA) field of the MAC control frame 511 is set to the MAC address of the rSTA device 520. In some embodiments, the transmitter address (TA) field of the defined MAC control frame 511 is set to the MAC address of the tSTA device 510, and the receiver address (RA) field of the MAC control frame 511 is set to the broadcast MAC address. The address information of the rSTA devices 520 can be included in the frame body of the MAC control frame with the rSTA's AID or the rSTA's MAC address.

After receiving the RTSA frame 511, the rSTA device 520, after a SIFS delay 521A, sends a Request to Send (RTS) (or MU-RTS) frame 521 to the destination station (dSTA) device 530 if the wireless medium is idle. Otherwise, the rSTA device 520 does not transmit the RTS frame to the dSTA device 530.

After receiving the RTS (or MU-RTS) frame 521, the dSTA device 530, after a SIFS delay 531A, sends a Clear to Send (CTS) frame 531 to the relay station (rSTA) device 520 if the wireless medium is idle.

After receiving the CTS frame 531, the rSTA device 520, after a SIFS delay 522A, sends a CTS-ACK frame 522 (e.g., CTS or CTS-to-self frame) to the transmit station (tSTA) device 510 or to the rSTA device 520.

After receiving the CTS-ACK frame 522, the tSTA device 510 has confirmed the TXOP protection for transmitting and forwarding frames over the rSTA device 520 to the dSTA device 530. As a result, the tSTA device 510, after a SIFS delay 512A, performs the relay operation to forward frames over the rSTA device 520 to the dSTA device 530 (e.g., transmission of DL/UL frame for relay). For example, after receiving the CTS-ACK frame 522, the tSTA device 510, after a SIFS delay 512A, may transmit a first PPDU-1 frame 512 to the rSTA device 520. For example, in the MAC control frame 511, the tSTA device 510 reserves a 5 milliseconds (ms) TXOP, out of which 3 ms is allocated to the rSTA device 520, and the tSTA device 510 uses 2 ms for transmitting the first PPDU-1 frame 512. In response to receiving the first PPDU-1 frame 512, the rSTA device 520 forwards the successfully received MPDUs carried in PPDU-1 512 in a second PPDU-2 frame 524 to the dSTA 530. As disclosed herein, the Modulation and Coding Scheme (MCS)/number of spatial streams (NSS) for the second PPDU-2 frame 524 may be informed to the rSTA device 520 with the information embedded in the first PPDU-1 frame 512 or in a separate management frame.

Prior to forwarding the second PPDU-2 frame 524, the rSTA device 520, after a SIFS delay 523A, may transmit a block acknowledgement (BA) 523 back to the tSTA device 510 if a hop-by-hop agreement is set up. However and as indicated with the dashed box 523, the BA 523 transmission may be skipped if it is indicated in the PPDU-1 frame or it has been preconfigured or negotiated as skipped before. The relay processing delay (t relay) is either pre-defined for any relays (e.g., being equal to Short Interframe Spacing (SIFS)), or per-determined by the rSTA device 520. In response to the second PPDU-2 data frame 524 and after a SIFS delay 532A, the dSTA device 530 sends an acknowledgement frame 532 (e.g., ACK, BA, multi-STA block Ack (M-BA)) back to the rSTA device 520. In addition and after a SIFS delay 525A, the rSTA device 520 forward the acknowledgement frame 532 (e.g., ACK, BA, M-BA) by sending another acknowledgement frame 525 (e.g., M-BA) back to the tSTA device 510.

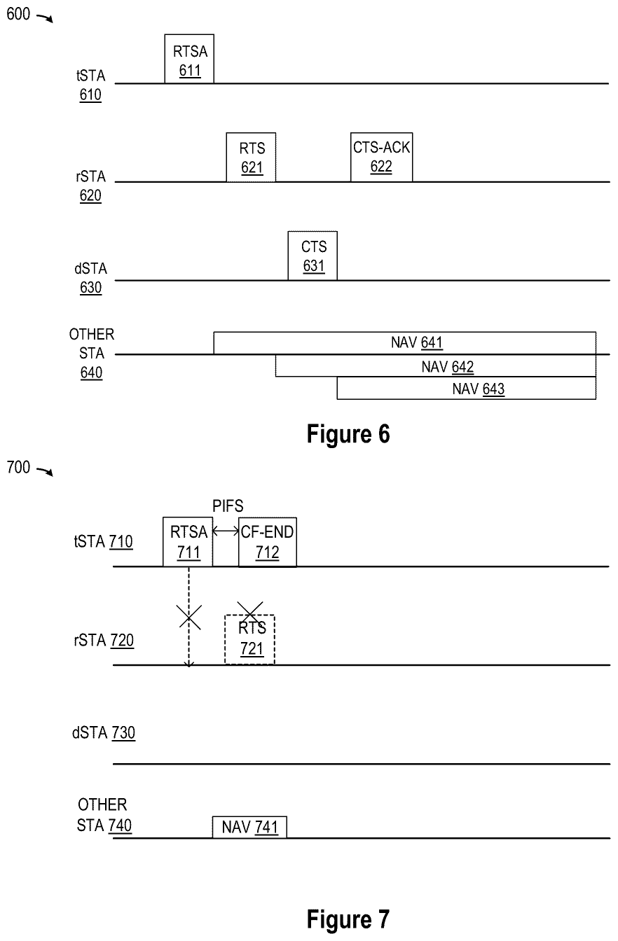

As disclosed herein, each of the MAC control frame 511, RTS (or MU-RTS) frame 521, CTS frame 531, and CTS-ACK frame 522 can be transmitted in a non-high throughput (HT) (duplicate) PPDU to support the NAV protection from other or legacy STAs. To provide an improved understanding of how other STAs can operate without interfering with the disclosed frame exchange sequence for providing relay TXOP protection, reference is now made to FIG. 6 which diagrammatically depicts a frame exchange sequence 600 between a tSTA 610, rSTA 620, dSTA 630, and a plurality of other station devices 640 in accordance with selected embodiments of the present disclosure. As depicted, each station 640 sets a network allocation vector (NAV) value 641-643 based on a MAC control frame (e.g., RTSA) 611, RTS (or MU-RTS) frame 621, or CTS frame 631 received from the tSTA 610 so that the existing NAV operation for the other station device(s) 640 is controlled by the exchange of RTS/CTS frame messages among the rSTA(s) 620 and dSTA 630.

In particular, the tSTA device 610 transmits the MAC control frame 611 (e.g., RTSA) to protect or reserve a transmission opportunity (TXOP) for a relay operation of frame exchange, where the MAC control frame 611 may be received by the rSTA device 620, dSTA device 630 and one or more of the other station devices 640. In some embodiments where one of the other STA devices 640 receives the RTSA frame 611, the other STA device 640 sets the NAV value 641 based on the value of the Duration field of the MAC header of the RTSA frame 611. As illustrated, the NAV value 641 is set to begin after receiving the RSTA frame 611, and to end at the end of the TXOP duration so that the other STA device 640 does not contend for channel access during the indicated NAV time period 641 unless the other STA device 640 receives a CF-End frame indicating the TXOP termination.

In response to the MAC control frame 611, the rSTA device 620 transmits an RTS (or MU-RTS) frame 621 which may be received by the dSTA device 630 and one of the one or more other station devices 640. In some embodiments where one of the other STA devices 640 receives the RTS (or MU-RTS) frame 621, the other STA device 640 sets the NAV value 642 based on the value of the Duration field of the MAC header of the RTS (or MU-RTS) frame 621. As illustrated, the NAV value 642 is set to begin after receiving the RTS (or MU-RTS) frame 621, and to end at the end of the TXOP duration so that the other STA device 640 does not contend for channel access during the indicated NAV time period 642 unless the other STA device 640 receives a CF-End frame indicating the TXOP termination.

In response to the RTS (or MU-RTS) frame 621, the dSTA device 630 transmits a CTS frame 631 if the wireless medium is idle. In some embodiments where one of the other STA devices 640 receives the CTS frame 631, the other STA device 640 sets the NAV value 643 based on the value of the Duration field of the MAC header of the CTS frame 631. As illustrated, the NAV value 643 is set to begin after receiving the CTS frame 631, or within a certain time interval (e.g., SIFS after the CTS frame 631), and to end at the end of the TXOP duration so that the other STA device 640 does not contend for channel access during the indicated NAV time period 643.

In response to the CTS frame 631, the rSTA device 620 transmits a CTS-ACK frame (or CTS frame) 622 which may be received by the tSTA device 610. At this point, the transmission opportunity for the tSTA device 610 is protected, and the tSTA device 610 performs the relay operation to forward a PPDU frame to the rSTA device 620, which in turn transmits a PPDU frame to the dSTA device 630, all without interference from the other STA device(s) 640 which maintain the NAV value(s) 641-643 until the end of the TXOP duration unless the other STA device(s) 640 receive a Contention Free-End (CF-END) frame.

To provide a detailed understanding of selected error handling embodiments that may be provided in connection with the disclosed frame exchange sequence for providing relay TXOP protection, reference is now made to FIG. 7 which diagrammatically depicts a frame exchange sequence 700 between a tSTA device 710, rSTA device 720, dSTA device 730, and one or more other station devices 740 where the tSTA device 710 performs a first error handling procedure if the tSTA 710 does not receive an RTS (or MU-RTS) frame 721 from an rSTA device 720. In particular, the tSTA device 710 transmits the MAC control frame 711 (e.g., RTSA) to protect or hold a transmission opportunity (TXOP) for a relay operation of frame exchange. In normal operation, the MAC control frame 711 is intended for reception by the rSTA device 720, dSTA device 730 and one or more of the other station devices 740 which provide one or more responses. For example, the rSTA device 720 normally responds to the RTSA frame 711 by generating and transmitting an RTS (or MU-RTS) frame 721 if the wireless medium is idle. In addition, the other STA device 740 receiving the RTSA frame 711 sets the NAV value 741 to begin after receiving the RSTA frame 711, and to end at the end of the TXOP duration so that the other STA device 740 does not contend for channel access during the indicated NAV time period 741. However, if channel conditions prevent the rSTA device 720 from receiving the RTSA frame 711 (as indicated by the “X” across the dashed line extending down from the RTSA 711) or if the wireless medium is busy, this would prevent the rSTA device 720 from transmitting a RTS (or MU-RTS) frame 721 (as indicated by the “X” across the RTS (or MU-RTS) frame 721). In this situation where the RTS (or MU-RTS) frame 721 is not transmitted, the tSTA device 710 is configured to wait for a predetermined time (e.g., a PIFS duration) after transmitting the RTSA frame 711 to perform a PIFS recovery procedure where the tSTA device 710 transmits a frame to the other STA 741. In addition or in the alternative, the tSTA device 710 performs a PIFS recovery procedure where the tSTA device 710 transmits a CF-End frame 712 to terminate the TXOP, there enabling the other STA device 740 to terminate the NAV value 741 so that the other STA device 740 may contend for channel access after the indicated NAV time period 741.

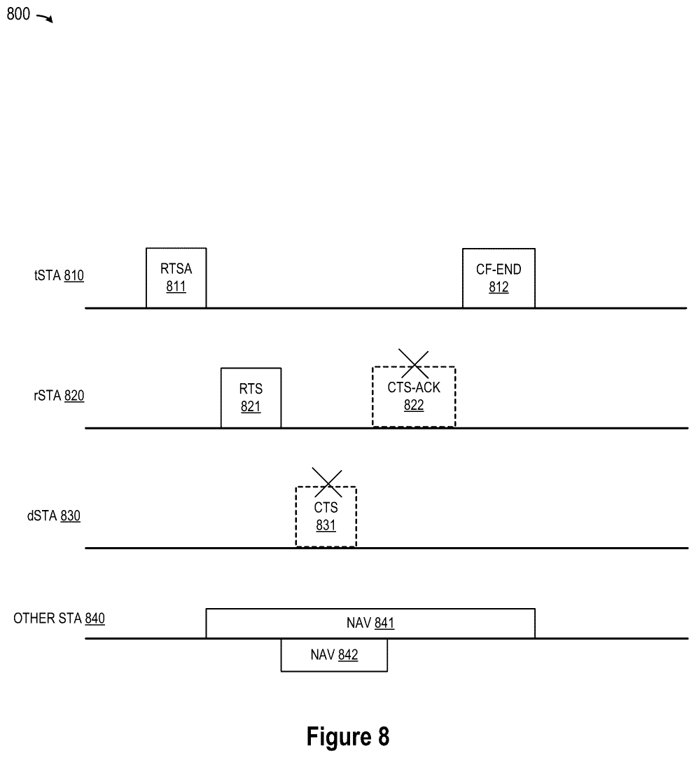

To provide a detailed understanding of additional error handling embodiments that may be provided in connection with the disclosed frame exchange sequence for providing relay TXOP protection, reference is now made to FIG. 8 which diagrammatically depicts a frame exchange sequence 800 between a tSTA device 810, rSTA device 820, dSTA device 830, and one or more other station devices 840 where the tSTA device 810 performs a second error handling procedure if the tSTA 810 does not timely receive an CTS-ACK frame 822 (or CTS frame) from the rSTA device 820. In normal operation, the tSTA device 810 transmits the MAC control frame 811 (e.g., RTSA frame) to the rSTA device 820, dSTA device 830 and one or more of the other station devices 840 which provide one or more responses. For example, the rSTA device 820 normally responds to the RTSA frame 811 by transmitting an RTS (or MU-RTS) frame 821 if the wireless medium is idle. In turn, the dSTA device 830 normally responds to the RTS (or MU-RTS) frame 821 by transmitting a CTS frame 831 if the wireless medium is idle. Finally, the rSTA device 820 normally responds to the CTS frame 831 by transmitting a CTS-ACK frame 822. In normal operation, the other STA device 840 also responds to the RTSA frame 811 by setting the NAV value 841 to begin after receiving the RSTA frame 811, and to end at the end of the TXOP duration so that the other STA device 840 does not contend for channel access during the indicated NAV time period 841. However, if channel conditions prevent the dSTA device 830 from transmitting a CTS frame 831 (as indicated by the “X” across the CTS frame 831) or if the wireless medium is busy, then the rSTA device 820 will not transmit a CTS-ACK frame 822 (as indicated by the “X” across the CTS-ACK frame 822). In this situation where the CTS-ACK frame 822 is not transmitted, the tSTA device 810 is configured to wait for a predetermined waiting time after transmitting the RTSA frame 811 to perform a recovery procedure where the tSTA device 810 transmits a frame to the other STA 841. In addition or in the alternative, the tSTA device 810 performs a recovery procedure where the tSTA device 810 transmits a CF-End frame 812 after the predetermined waiting time to terminate the TXOP, there enabling the other STA device 840 to terminate the NAV value 841 so that the other STA device 840 may contend for channel access after the indicated NAV time period 841. As disclosed herein, the predetermined waiting time interval may equal a SIFS time+CTS transmission time+CTSTimeout interval. Alternatively, the predetermined waiting time interval may equal 2×SIFS Time+2×CTS transmission time.

In normal operation, an RTS (or MU-RTS) frame 821 transmitted by an rSTA device 820 may be received by one of the other STA devices 840 which responds by setting the NAV value 842 based on the value of the Duration field of the MAC header of the RTS frame 821. As illustrated, the NAV value 842 is set to begin after receiving the RTS (or MU-RTS) frame 821, and the NAV value 842 would normally end at the end of the TXOP duration so that the other STA device 840 does not contend for channel access during the indicated NAV time period 842. However, in this situation where the CTS frame 831 is not transmitted, the other STA device 840 is configured to wait for a predetermined time after receiving the RTS (or MU-RTS) frame 821 to perform a recovery procedure where the other STA device 840 terminates the NAV value 842 so that the other STA device 740 may contend for channel access after the indicated NAV time period 842.

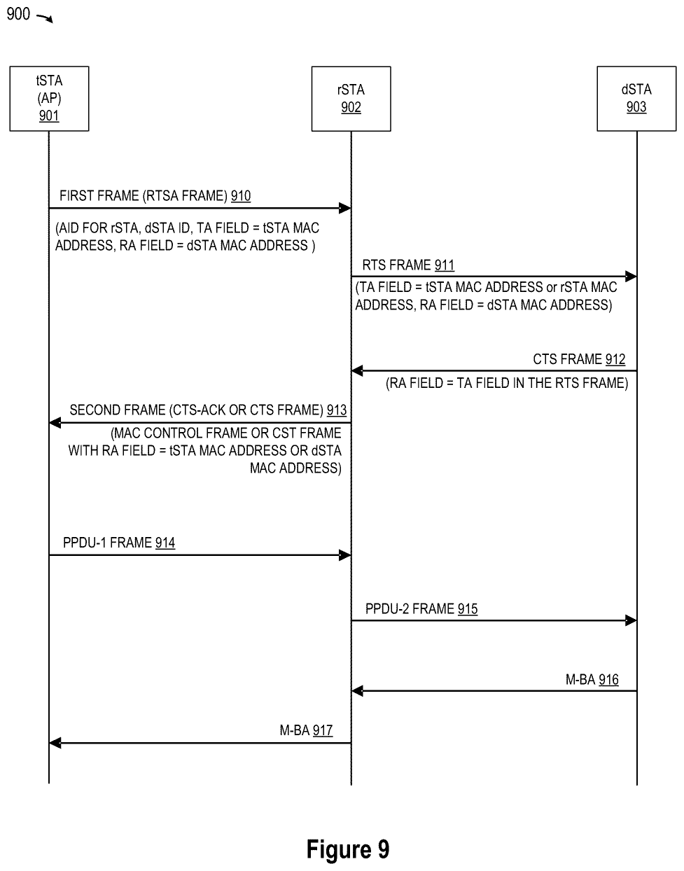

To provide additional details for an improved understanding of selected embodiments of the present disclosure, reference is now made to FIG. 9 which diagrammatically illustrates a message flow signaling sequence 900 during operation of a plurality of wireless communication station (STA) devices 901-903 which use a MAC control frame and a sequence of RTS (or MU-RTS), CTS, and CTS-ACK frame signaling messages to protect or hold a transmission opportunity (TXOP) for a relay operation. In the depicted signaling sequence, a first wireless communication STA device is a transmitting station (tSTA) device 901 that seeks to reserve or protect a transmission opportunity time window for a relay operation to exchange frames over a relay wireless communication STA (rSTA) device 902 with a destination wireless communication STA (dSTA) device 903. To this end, the tSTA device 901 (e.g., an AP) transmits a first frame 910 to reserve the TXOP for multiple hops (i.e., the tSTA 302 and the rSTA902). As disclosed herein, the first frame 910 may be a Request to Send Announcement (RTSA) frame or a modified MU-RST TXS frame that includes a TXOP duration information, an address information for the rSTA device 902, and an address information for the dSTA device 903.

In response to the first frame 910, the rSTA device(s) 902 transmits a Request to Send (RTS) (or MU-RTS) frame 911 to the dSTA device 903 if the wireless medium is idle. As disclosed herein, the RTS (or MU-RTS) frame 911 may include a TXOP duration information, a MAC address for the rSTA device(s) 902, and an address for the dSTA device 903 that is a target recipient of the RTS (or MU-RTS) frame.

In response to the RTS (or MU-RTS) frame 911, the dSTA device(s) 903 transmits a Clear to Send (CTS) frame 912 if the wireless medium is idle.

In response to the CTS frame 912, the rSTA device 902 transmits a second frame 913 to the tSTA device 901 or to the rSTA itself. As disclosed herein, second frame 913 may be transmitted as a CTS-ACK (or CTS) frame having a receiver address (RA) field set to the MAC address of the tSTA device 901. Alternatively, the second frame 913 may be a CTS-to-self frame.

In response to the second frame 913, the tSTA device 901 is configured to transmit a first PPDU-1 frame 914 to the rSTA(s) 902. For example, if the first frame 910 transmitted by the tSTA device 901 reserves a 5 milliseconds (ms) TXOP with 3 ms allocated to the rSTA device(s) 902, then the tSTA device 901 uses 2 ms for transmitting the first PPDU-1 frame 914 to the rSTA device 902. In turn, the rSTA device(s) 902 can forward the second PPDU-2 frame 915 that is successfully received MPDUs in the first PPDU-1 frame 914 by the rSTA device 902 to the dSTA device 903.

In response to the second PPDU-2 data frame 915, the dSTA device 903 sends an acknowledgment frame 916 (e.g., Ack, BA, or a M-BA) back to the rSTA device(s) 902, which may send an M-BA 917 back to the tSTA device 901.

While the disclosed first frame 910, RTS frame 911, CTS frame 912, and CTS-ACK frame 913 can be transmitted with non-HT (DUP) PPDUs to support the NAV protection from legacy STAs

By now it should be appreciated that there has been provided an apparatus, method, and system for relaying one or more frames at a wireless relay station (STA) device from a first STA device to a second STA device in a wireless area network in accordance with a predetermined wireless protocol (e.g., the IEEE 802.11 protocol). In the disclosed methodology, the wireless relay STA device receives a first Medium Access Control (MAC) control frame to protect a transmission opportunity for a relay operation of frames exchanged between a first STA device and a second STA device over a wireless relay STA device, where the first MAC control frame includes TXOP duration information, receiver address information identifying the wireless relay STA device as a receiver device for the first MAC control frame, transmitter address information identifying the first STA device as a transmitter device for the first MAC control frame, and address information identifying the second STA device. In selected embodiments, the first STA device is an access point (AP) and the second STA device is a non-AP station (STA). In selected embodiments, the first MAC control frame may be implemented with a modified MU-RTS Trigger frame, a modified MU-RTS TXS Triggered TXOP sharing trigger frame, or a Request-to-Send Announcement (RTSA) frame which triggers the wireless relay STA device to transmit the second MAC control frame. In selected embodiments, the first MAC control frame triggers transmission of the second MAC control frame from the wireless relay STA device to the second STA device. In addition, the wireless relay STA device transmits a second MAC control frame in response to receiving the first MAC control frame. In selected embodiments, the second MAC control frame may be implemented with a Request-to-Send (RTS) frame or a Multi-User Request-to-Send (MU-RTS) Trigger frame. In selected embodiments, the wireless relay STA device transmits the second MAC control frame when a wireless medium at the wireless relay STA device is idle. In addition, the wireless relay STA device receives and processes a third MAC control frame that is transmitted by the second STA device in response to receiving the second MAC control frame. In selected embodiments, the third MAC control frame may be implemented with a Clear-to-Send (CTS) frame addressed to the wireless relay STA device. In selected embodiments, the second STA device transmits the third MAC control frame when a wireless medium at the second STA device is idle. In addition, the wireless relay STA device transmits a fourth MAC control frame in response to receiving the third MAC control frame to confirm completion of a TXOP protection frame exchange sequence. In selected embodiments, the fourth MAC control frame may be implemented with a Clear-to-Send (CTS) frame addressed to at least one of the first STA device or the wireless relay STA device. In addition, the wireless relay STA device receives a first frame from the first STA device. In addition, the wireless relay STA device forwards the first frame to the second STA device. In some embodiments of the disclosed methodology, the wireless relay STA device transmits a block acknowledgement (BA) frame to the first STA device in response to receiving the first frame from the first STA device. In some embodiments of the disclosed methodology, the wireless relay STA device receives a first block acknowledgement (BA) frame that is transmitted by the second STA device in response to the first frame being forwarded to the second STA device. In such embodiments of the disclosed methodology, the wireless relay STA device also transmits a second block acknowledgement (BA) frame in response to receiving the first block acknowledgement (BA) message from the second STA device.

In another form, there is provided an apparatus, method, and system for protecting a transmission opportunity (TXOP) for relay operation of frames exchanged between a transmitter station (tSTA) device and a destination STA (dSTA) device over a relay STA (rSTA) device. In the disclosed methodology, the tSTA device transmits a first Medium Access Control (MAC) control frame to at least the rSTA device, where the first MAC control frame includes TXOP duration information, transmitter address information identifying the tSTA device as a transmitter device for the first MAC control frame, receiver address information identifying the rSTA device as a receiver device for the first MAC control frame, and address information identifying the dSTA device, and where the first MAC control frame instructs the rSTA device to transmit a second MAC control frame to at least the dSTA device. In selected embodiments, the transmitter address information in the first MAC control frame is a Transmitter Address (TA) field set to a MAC address of the tSTA device, and the receiver address information in the first MAC control frame is a Receiver Address (RA) field set to the rSTA device. In addition, the tSTA device detects whether the rSTA device transmits the second MAC control frame at a first time window specified by the TXOP duration information and whether the rSTA device transmits a third MAC control frame at a second time window specified by the TXOP duration information. In selected embodiments, the second MAC control frame is selected from a group consisting of a Request-to-Send (RTS) frame or a Multi-User Request-to-Send (MU-RTS) Trigger frame. In selected embodiments, the third MAC control frame is a Clear-to-Send (CTS) frame that includes a Receiver Address (RA) field set to a MAC address of the tSTA device or a MAC address of the rSTA device. In addition, the tSTA device transmits a frame to at least the rSTA device during a TXOP-protected window designated by the TXOP duration information for forwarding to the dSTA device if the tSTA device detects the second MAC control frame at the first time window and also detect the third MAC control frame at the second time window. In selected embodiments of the disclosed methodology, the tSTA device transmits a Contention Free-End (CF-END) frame to terminate the transmission opportunity if the tSTA device does not detect the second MAC control frame at the first time window. In selected embodiments of the disclosed methodology, the tSTA device transmits a Contention Free-End (CF-END) frame to terminate the transmission opportunity if the tSTA device does not detect the third MAC control frame at the second time window.

In yet another form, there is provided a wireless transmitter device, method, and system for transmitting one or more frames in accordance with IEEE 802.11 protocol. The disclosed wireless transmitter device includes a transceiver to exchange one or more frames with one or more wireless devices, a processor, and a memory storing instructions. When executed by the processor, the instructions cause the wireless transmitter device to transmit a Medium Access Control (MAC) control frame to at least a wireless relay device, where the MAC control frame includes transmission opportunity (TXOP) duration information, address information for the wireless destination device, a Transmitter Address (TA) field set to a MAC address of the wireless transmitter device, and a Receiver Address (RA) field set to a MAC address of the wireless relay device, and where the MAC control frame instructs the wireless relay device to transmit a Request-to-Send (RTS) frame (or MU-RTS Trigger frame) to at least a wireless destination device. In selected embodiments, the execution of the instructions at the processor also causes the wireless transmitter device to detect whether the wireless relay device transmits the RTS (or MU-RTS Trigger) frame in a first time window and whether the wireless relay device transmits a Clear-to-Send (CTS) frame in a second time window. In addition, the execution of the instructions at the processor causes the wireless transmitter device to transmit one or more frames to at least the wireless relay device at a first TXOP-protected transmission time designated by the TXOP duration information for forwarding to the wireless destination device if the wireless transmitter device detects that the RTS frame (or MU-TRS Trigger frame) is transmitted at the first time window and the CTS frame is transmitted at the second time window.

In still yet another form, there is provided a wireless relay device, method, and system for transmitting one or more frames in accordance with IEEE 802.11 protocol. The disclosed wireless relay device includes a transceiver to exchange one or more frames with one or more wireless devices, a processor, and a memory storing instructions. When executed by the processor, the instructions cause the wireless relay device to receive a Medium Access Control (MAC) control frame to protect a transmission opportunity for a relay operation transmitted by a wireless transmitter device to a wireless destination device, where the MAC control frame includes TXOP duration information, address information of the destination station device, receiver address information identifying the wireless relay device as a receiver device for the MAC control frame, and transmitter address information identifying the wireless transmitter device as a transmitter device for the MAC control frame. In selected embodiments, the MAC control frame includes address information identifying the wireless destination device, a Transmitter Address (TA) field set to a MAC address of the wireless transmitter device, and a Receiver Address (RA) field set to a MAC address of the wireless relay device. The execution of the instructions at the processor also causes the wireless relay device to transmit a Request-to-Send (RTS) (or MU-RTS Trigger) frame in response to receiving the MAC control frame, where the RTS (or MU-RTS Trigger) frame includes the TXOP duration information, receiver address information identifying the wireless destination device as a receiver device for the RTS frame, and transmitter address information identifying the wireless relay device. In addition, the execution of the instructions at the processor causes the wireless relay device to receive a first Clear-to-Send (CTS) frame that is transmitted by the wireless destination device in response to receiving the RTS (or MU-RTS Trigger) frame. The execution of the instructions at the processor also causes the wireless relay device to transmit a second CTS frame in response to receiving the first CTS frame. In addition, the execution of the instructions at the processor causes the wireless relay device to receive a first frame from the wireless transmitter device which is transmitted during the TXOP duration, and to forward the first data frame to the wireless destination device.

The present invention is not necessarily limited to the example embodiments which illustrate inventive aspects of the present invention that are applicable to a wide variety of circuit designs and operations. Thus, the particular embodiments disclosed above are illustrative only and should not be taken as limitations upon the present invention, as the invention may be modified and practiced in different but equivalent manners apparent to those skilled in the art having the benefit of the teachings herein. Accordingly, the identification of the circuit design and configurations provided herein is merely by way of illustration and not limitation and other circuit arrangements may be used in order to use a MAC control frame, such as an RTS Announcement (RTSA) frame, with exchanged RTS (or MU-RTS), CTS, and CTS-ACK frames to protect or reserve a transmission opportunity (TXOP) for a relay operation. Accordingly, the foregoing description is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

At least some of the various blocks, operations, and techniques described above may be implemented utilizing hardware, a processor executing firmware instructions, a processor executing software instructions, or any combination thereof. When implemented utilizing a processor executing software or firmware instructions, the software or firmware instructions may be stored in any computer readable memory such as on a magnetic disk, an optical disk, or other storage medium, in a RAM or ROM or flash memory, processor, hard disk drive, optical disk drive, tape drive, etc. The software or firmware instructions may include machine readable instructions that, when executed by one or more processors, cause the one or more processors to perform various acts. When implemented in hardware, the hardware may comprise one or more of discrete components, an integrated circuit, an application-specific integrated circuit (ASIC), a programmable logic device (PLD), etc.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method for relaying one or more frames at a wireless relay station (STA) device from a first STA device to a second STA device in accordance with Institute of Electrical and Electronics Engineers (IEEE) 802.11 protocol, comprising:
receiving, by the wireless relay STA device, a first Medium Access Control (MAC) control frame to protect a transmission opportunity for a relay operation of frames exchanged between a first STA device and a second STA device over the wireless relay STA device, where the first MAC control frame comprises transmission opportunity (TXOP) duration information, receiver address information identifying the wireless relay STA device as a receiver device for the first MAC control frame, transmitter address information identifying the first STA device as a transmitter device for the first MAC control frame, and address information identifying the second STA device;
transmitting, by the wireless relay STA device to the second STA device, a second MAC control frame in response to the wireless relay STA device receiving the first MAC control frame;
receiving and processing, by the wireless relay STA device, a third MAC control frame that is transmitted by the second STA device in response to receiving the second MAC control frame; and
transmitting, by the wireless relay STA device, a fourth MAC control frame in response to receiving the third MAC control frame to confirm completion of a TXOP protection frame exchange sequence.

2. The method of claim 1, further comprising:
receiving, by the wireless relay STA device, a first frame from the first STA device; and
forwarding, by the wireless relay STA device, the first frame to the second STA device.

3. The method of claim 1, where the first MAC control frame is selected from a group consisting of a modified Multi-User Request-to-Send (MU-RTS) Trigger frame, a modified MU-RTS TXS Triggered TXOP sharing Trigger frame or a Request-to-Send Announcement (RTSA) frame which triggers the wireless relay STA device to transmit the second MAC control frame.

4. The method of claim 1, where the second MAC control frame is selected from a group consisting of a Request-to-Send (RTS) frame or a Multi-User Request-to-Send (MU-RTS) Trigger frame.

5. The method of claim 1, where the third MAC control frame is a Clear-to-Send (CTS) frame addressed to the wireless relay STA device.

6. The method of claim 1, where the fourth MAC control frame comprises a Clear-to-Send (CTS) frame addressed to at least one of the first STA device or the wireless relay STA device.

7. The method of claim 1, wherein the first STA device is an access point (AP) and the second STA device is a non-AP station (STA).

8. The method of claim 1, wherein the first MAC control frame triggers transmission of the second MAC control frame from the wireless relay STA device to the second STA device.

9. The method of claim 1, wherein the wireless relay STA device transmits the second MAC control frame when a wireless medium at the wireless relay STA device is idle.

10. The method of claim 1, wherein the second STA device transmits the third MAC control frame when a wireless medium at the second STA device is idle.

11. A method for protecting a transmission opportunity (TXOP) for relay operation of frames exchanged between a transmitter station (tSTA) device and a destination STA (dSTA) device over a relay STA (rSTA) device, comprising:
transmitting, by the tSTA device, a first Medium Access Control (MAC) control frame to at least the rSTA device, where the first MAC control frame comprises TXOP duration information, transmitter address information identifying the tSTA device as a transmitter device for the first MAC control frame, receiver address information identifying the rSTA device as a receiver device for the first MAC control frame, and address information identifying the dSTA device, and where the first MAC control frame instructs the rSTA device to transmit a second MAC control frame to at least the dSTA device;
detecting, by the tSTA device, whether the rSTA device transmits the second MAC control frame at a first time window specified by the TXOP duration information and whether the rSTA device transmits a third MAC control frame at a second time window specified by the TXOP duration information; and
transmitting, by the tSTA device, a frame to at least the rSTA device during a TXOP-protected window designated by the TXOP duration information for forwarding to the dSTA device if the tSTA device detects the second MAC control frame at the first time window and also detect the third MAC control frame at the second time window.

12. The method of claim 11, where the transmitter address information in the first MAC control frame comprises a Transmitter Address (TA) field set to a MAC address of the tSTA device, and where the receiver address information in the first MAC control frame comprises a Receiver Address (RA) field set to the rSTA device.

13. The method of claim 11, wherein the second MAC control frame is selected from a group consisting of a Request-to-Send (RTS) frame or a Multi-User Request-to-Send (MU-RTS) Trigger frame.

14. The method of claim 11, where the third MAC control frame is a Clear-to-Send (CTS) frame that includes a Receiver Address (RA) field set to a MAC address of the tSTA device or a MAC address of the rSTA device.

15. The method of claim 11, further comprising transmitting, by the tSTA device, a Contention Free-End (CF-END) frame to terminate the transmission opportunity if the tSTA device does not detect the second MAC control frame at the first time window.

16. The method of claim 11, further comprising transmitting, by the tSTA device, a Contention Free-End (CF-END) frame to terminate the transmission opportunity if the tSTA device does not detect the third MAC control frame at the second time window.

17. A wireless transmitter device for transmitting one or more frames in accordance with Institute of Electrical and Electronics Engineers 802.11 protocol, comprising:
a transceiver to exchange one or more frames with one or more wireless devices;
a processor; and
a memory storing instructions that, when executed by the processor, cause the wireless transmitter device to:
transmit a Medium Access Control (MAC) control frame to at least a wireless relay device, where the MAC control frame comprises transmission opportunity (TXOP) duration information, address information for the wireless destination device, a Transmitter Address (TA) field set to a MAC address of the wireless transmitter device, and a Receiver Address (RA) field set to a MAC address of the wireless relay device, and where the MAC control frame instructs the wireless relay device to transmit a Request-to-Send (RTS) or multi-user RTS (MU-RTS) Trigger frame to at least a wireless destination device.

18. The wireless transmitter device of claim 17, where the instructions stored in memory, when executed by the processor, cause the wireless transmitter device to:
detect whether the wireless relay device transmits the RTS or MU-RTS Trigger frame in a first time window and whether the wireless relay device transmits a Clear-to-Send (CTS) frame in a second time window; and
transmit one or more frames to at least the wireless relay device at a first TXOP-protected transmission time designated by the TXOP duration information for forwarding to the wireless destination device if the wireless transmitter device detects that the RTS or MU-RTS Trigger frame is transmitted at the first time window and the CTS frame is transmitted at the second time window.

19. A wireless relay device for transmitting one or more frames in accordance with Institute of Electrical and Electronics Engineers (IEEE) 802.11 protocol, comprising:
a transceiver to exchange one or more frames with one or more wireless devices;
a processor; and
a memory storing instructions that, when executed by the processor, cause the wireless relay device to:
receive a Medium Access Control (MAC) control frame to protect a transmission opportunity for a relay operation transmitted by a wireless transmitter device to a wireless destination device, where the MAC control frame comprises transmission opportunity (TXOP) duration information, address information of the destination station device, receiver address information identifying the wireless relay device as a receiver device for the MAC control frame, and transmitter address information identifying the wireless transmitter device as a transmitter device for the MAC control frame;
transmit a Request-to-Send (RTS) or multi-user RTS (MU-RTS) Trigger frame in response to receiving the MAC control frame, where the RTS or MU-RTS Trigger frame comprises the TXOP duration information, receiver address information identifying the wireless destination device as a receiver device for the RTS frame, and transmitter address information identifying the wireless relay device;
receive a first Clear-to-Send (CTS) frame that is transmitted by the wireless destination device in response to receiving the RTS or MU-RTS Trigger frame; and
transmit a second CTS frame in response to receiving the first CTS frame.

20. The wireless relay device of claim 19, where MAC control frame comprises:
address information identifying the wireless destination device;
a Transmitter Address (TA) field set to a MAC address of the wireless transmitter device; and
a Receiver Address (RA) field set to a MAC address of the wireless relay device.
